(19) United States
(12) Patent Application Publication
(10) Pub. No.: US 2025/0206309 A1
(43) Pub. Date: Jun. 26, 2025

(54) Method and Device for Controlling the Coasting Mode of a Motor Vehicle

(71) Applicant: Bayerische Motoren Werke Aktiengesellschaft, Muenchen (DE)

(72) Inventors: Helena DOLINAJ, Muenchen (DE); Miguel LOENNE, Muenchen (DE); Sebastien MATHIEU, Fuerstenfeldbruck (DE)

(21) Appl. No.: 18/848,952

(22) PCT Filed: Mar. 15, 2023
(86) PCT No.: PCT/EP2023/056596

§ 371 Date: Sep. 20, 2024

(30) Foreign Application Priority Data
Mar. 21, 2022 (DE) 10 2022 106 572.3

(51) Int. Cl. B60W 30/18; B60W 50/00

(52) U.S. Cl. CPC B60W 30/18072; B60W 50/0097; B60W 2520/10; B60W 2720/103

(57) ABSTRACT

The present disclosure relates to a device for controlling the coasting mode of a vehicle in the context of a distance control and/or speed control function of the vehicle. In one form, a device is designed to predict a distance and/or speed graph for the vehicle in the coasting mode on the basis of a current degree of advancement of the vehicle, and to compare the predicted distance and/or speed graph for the vehicle with a target distance and/or a target speed of the distance control and/or speed control function of the vehicle. The device is also designed to control the coasting mode depending on the comparison.

### BACKGROUND AND SUMMARY

The present disclosure relates to a motor vehicle that is designed to be operated in a coasting mode. In particular, the present disclosure relates to a method and a corresponding device for controlling the coasting mode of the motor vehicle in an open-loop manner.

A vehicle with an internal combustion engine may be designed to occasionally decouple the internal combustion engine from the drive train of the vehicle during a journey and possibly shut it down in order to reduce the energy consumption of the vehicle. In other words, the vehicle may be designed to be occasionally operated in the coasting mode during a journey.

The present document deals with the technical object of efficiently enabling a particularly energy-efficient coasting mode of a vehicle, in particular in connection with closed-loop distance and/or speed control of the vehicle.

The object is achieved by each of the independent claims. Advantageous embodiments and implementations are described, inter alia, in the dependent claims. It is pointed out that additional features of a patent claim dependent on an independent patent claim can form, without the features of the independent patent claim or only in combination with a subset of the features of the independent patent claim, a separate invention that is independent of the combination of all features of the independent patent claim and can be made into the subject matter of an independent claim, a divisional application or a subsequent application. This applies, in the same manner, to technical teachings that are described in the description and can form an invention independent of the features of the independent patent claims.

One aspect describes an (open-loop control) device for controlling the coasting mode of a (motor) vehicle in an open-loop manner as part of closed-loop distance and/or speed control of the vehicle. During operation of the closed-loop distance and/or speed control, the driving speed can be automatically adapted on the basis of a target distance (specified by the driver) to the leading vehicle driving (directly) in front of the vehicle and/or (in the case of unobstructed travel) on the basis of a target speed (specified by the driver), in particular can be controlled (to the target distance and/or the target speed) in a closed-loop manner.

The device may be configured to decouple the drive motor (in particular the internal combustion engine) of the vehicle from the drive train of the vehicle (and possibly to deactivate the drive motor) in order to start the coasting mode. Alternatively or additionally, the device may be configured to couple the drive motor to the drive train of the vehicle (and possibly to activate the drive motor) in order to end the coasting mode. During the coasting mode, the vehicle can roll without the action of a drive torque and/or a drag torque of the drive motor.

During the coasting mode of the vehicle, no drive torque is therefore typically caused by the drive motor of the vehicle. If appropriate, no braking torque can be caused (by one or more friction brakes of the vehicle) during the coasting mode either. No active closed-loop distance and/or speed control can therefore possibly take place during the coasting mode. However, it is possible to monitor that the distance between the vehicle and the leading vehicle does not fall below the target and/or that the driving speed of the vehicle remains within a predefined tolerance band around the target speed distance during the coasting mode. Active closed-loop distance and/or speed control (to the target distance and/or the target speed) can be carried out outside of the coasting mode. In particular, it is possible to cause the distance and/or the driving speed to be directly adjusted to the target distance and/or the target speed after the coasting mode has been ended.

The device is configured to predict a distance and/or speed profile of the vehicle in the coasting mode on the basis of a current driving progress point of the vehicle (for example on the basis of the current time and/or on the basis of the current position). The predicted distance and/or speed profile can indicate the temporal and/or spatial distance between the vehicle and the leading vehicle driving (directly) in front of the vehicle and/or the driving speed of the vehicle as a function of the driving progress (on the basis of the current driving progress point). In this case, the predicted distance and/or speed profile can extend over a predefined prediction horizon starting from the current driving progress point.

The driving progress can indicate or correspond to the position of the vehicle along the road used by the vehicle. Alternatively or additionally, the driving progress can indicate or correspond to the respective time during the journey of the vehicle. The prediction horizon can therefore correspond to a particular distance and/or time horizon (for example 100 meters or more, or 500 meters or more; or 10 seconds or more, or 20 seconds or more).

The device may be configured to determine an upcoming gradient profile of the road used by the vehicle (for the prediction horizon). This information may be determined on the basis of a digital map for the road network used by the vehicle. The distance and/or speed profile of the vehicle in the coasting mode can then be precisely predicted on the basis of the upcoming gradient profile.

The device may also be configured to determine state data relating to the state (for example the current driving speed) of the vehicle and/or relating to the state (for example the current driving speed) of the leading vehicle driving in front of the vehicle. The distance and/or speed profile of the vehicle in the coasting mode can then be predicted in a particularly precise manner on the basis of the state data.

When predicting the distance and/or speed profile of the vehicle, it can be assumed that the vehicle is in the coasting mode during the entire prediction horizon. Furthermore, it is possible to make an assumption with respect to the behavior of the leading vehicle during the prediction horizon. For example, it can be assumed that the driving speed of the leading vehicle remains constant during the entire prediction horizon.

The device is also configured to compare the predicted distance and/or speed profile of the vehicle with the target distance and/or the target speed from the closed-loop distance and/or speed control of the vehicle. In particular, the predicted distance profile can be compared with the target distance. Alternatively or additionally, the predicted speed profile can be compared with the target speed. During the comparison, it is possible to determine, for example,
the driving progress section in which the predicted distance and/or speed profile remains within a predefined tolerance band around the target distance and/or the target speed; and/or
the driving progress point at which the predicted distance and/or speed profile reaches (and then possibly falls below or exceeds) the target distance and/or the target speed.

The coasting mode can then be controlled in an open-loop manner, in particular started or ended, on the basis of the comparison (in particular on the basis of the determined driving progress section and/or on the basis of the determined driving progress point). It is thus possible to achieve a particularly energy-efficient and comfortable coasting mode of a vehicle with active closed-loop distance and/or speed control. In this case, there may be a deviation from the target distance and/or the target speed during the closed-loop distance and/or speed control and/or during the coasting mode at least occasionally and/or within a particular tolerance band. The tolerance band may be, for example, ±5% or less, or ±10% or less of the target distance and/or the target speed.

The device may be configured, while the vehicle is not operated in the coasting mode (and during active closed-loop distance and/or speed control), to determine whether or not the predicted distance and/or speed profile of the vehicle will reach the target distance and/or the target speed at an upcoming driving progress point. The coasting mode can be (selectively) started, for example at the current driving progress point of the vehicle, in particular can possibly be started only when it is determined that the predicted distance and/or speed profile of the vehicle will reach the target distance and/or the target speed. This makes it possible to enter the coasting mode in a particularly energy-efficient and/or comfortable manner.

The device may be configured, while the vehicle is operated in the coasting mode (and possibly no active closed-loop distance and/or speed control takes place), to determine an upcoming driving progress point at which the predicted distance and/or speed profile of the vehicle will reach the target distance and/or the target speed. An exit driving progress point can then be determined on the basis of the determined upcoming driving progress point. In this case, the device may be configured to determine an exit driving progress point that is before the determined upcoming driving progress point, in particular is before the determined upcoming driving progress point by a predefined offset value. The offset value may be, for example, 10 meters or less, or 2 seconds or less. The coasting mode can then be ended (and the closed-loop distance and/or speed control can be automatically activated) at the determined exit driving progress point. This makes it possible to exit the coasting mode in a particularly comfortable and energy-efficient manner (without post-acceleration by the drive motor of the vehicle) in order to achieve the situation in which the vehicle has the target distance and/or the target speed after the coasting mode has been ended.

The device may be configured, while the vehicle is not operated in the coasting mode (and while closed-loop distance control with respect to a leading vehicle is carried out), to predict the distance profile of the distance between the vehicle and the leading vehicle driving in front of the vehicle in the coasting mode. It is also possible to determine whether or not the predicted distance profile falls below the target distance by precisely or at least a predefined penetration depth (for example between 5% and 10%). The coasting mode can be started (at the current driving progress point), in particular possibly started only when it is determined that the predicted distance profile falls below the target distance by precisely or at least the predefined penetration depth. This makes it possible to subsequently exit the coasting mode in a particularly energy-efficient and/or comfortable manner.

The device may be configured, while the vehicle is operated in the coasting mode (and closed-loop distance control is carried out after exiting the coasting mode), to predict the distance profile of the distance between the vehicle and the leading vehicle driving in front of the vehicle during the coasting mode. It is then possible to determine the upcoming driving progress point at which the predicted distance profile of the vehicle will reach the target distance (for the first time). The coasting mode can then be ended in a particularly energy-efficient and comfortable manner at an exit driving progress point that is dependent on the determined upcoming driving progress point.

The device may be configured, while the vehicle is not operated in the coasting mode (and while closed-loop driving speed control is carried out), to predict the speed profile of the driving speed of the vehicle during the coasting mode (in this case, it can be assumed that no closed-loop speed control is carried out during the coasting mode).

The device may also be configured to determine a contiguous driving progress section, starting from the current driving progress point, in which the driving speed of the vehicle remains within the predefined tolerance range around the target speed. The contiguous driving progress section can also be determined in such a manner that the predicted speed profile has the target speed at the end of the contiguous driving progress section. The coasting mode can be (selectively) started, in particular started only when the temporal and/or spatial length of the contiguous driving progress section is greater than or equal to a temporal and/or spatial minimum length. The minimum length may be, for example, 50 meters or more or 5 seconds or more. This enables a particularly energy-efficient and comfortable coasting mode.

The device may be configured, while the vehicle is operated in the coasting mode (and closed-loop speed control is carried out after exiting the coasting mode), to predict the speed profile of the driving speed of the vehicle during the coasting mode. It is then possible to determine the upcoming driving progress point at which the predicted speed profile of the vehicle will reach the target speed (for the first time). Furthermore, the coasting mode can be ended at an exit driving progress point that is dependent on the determined upcoming driving progress point in order to exit the coasting mode in a particularly energy-efficient and/or comfortable manner with subsequent closed-loop control of the driving speed.

The device may be configured to repeatedly carry out the measures described in this document at a sequence of successive driving progress points (in particular times and/or positions). The device may be configured to predict a distance and/or speed profile of the vehicle in the coasting mode on the basis of the respective current driving progress point. The device may also be configured to compare the respectively predicted distance and/or speed profile of the vehicle with the target distance and/or the target speed from the closed-loop distance and/or speed control of the vehicle. In addition, the device may be configured to control the coasting mode in an open-loop manner, in particular to start or end it, at the respective current driving progress point on the basis of the comparison. This makes it possible to achieve a permanently energy-efficient and/or comfortable coasting mode with active closed-loop distance and/or speed control.

A further aspect describes a (road) motor vehicle (in particular an automobile or a truck or a bus or a motorcycle) that comprises the (open-loop control) device described in this document.

A further aspect describes a method for controlling the coasting mode of a vehicle in an open-loop manner as part of (active) closed-loop distance and/or speed control of the vehicle. In this case, the coasting mode can be embedded in closed-loop distance and/or speed control. In this case, the active closed-loop distance and/or speed control can be carried out automatically when the vehicle is not operated in the coasting mode. The coasting mode can be limited such that the target distance is not undershot and/or the target speed remains within a particular tolerance band during the coasting mode.

The method comprises predicting a distance and/or speed profile of the vehicle in the (pure and/or continuous) coasting mode on the basis of a current driving progress point of the vehicle. The method also comprises comparing the predicted distance and/or speed profile of the vehicle with the target distance (specified by the driver) and/or the target speed (specified by the driver) from the closed-loop distance and/or speed control of the vehicle. The method also comprises controlling the coasting mode in an open-loop manner, in particular starting or ending it, on the basis of the comparison.

A further aspect describes a software (SW) program. The SW program can be configured to be executed on a processor (for example on a control unit of a vehicle) and to thereby carry out the method described in this document.

A further aspect describes a storage medium. The storage medium may comprise a SW program which is configured to be executed on a processor and to thereby carry out the method described in this document.

It should be noted that the methods, devices and systems described in this document can be used both alone and in combination with other methods, devices and systems described in this document. Furthermore, any aspects of the methods, devices and systems described in this document can be combined with one another in various ways. In particular, the features of the claims can be combined with one another in various ways. Furthermore, features cited in parentheses should be understood as optional features.

### BRIEF DESCRIPTION OF THE DRAWINGS

The invention is described in more detail below on the basis of exemplary embodiments. In this case,

FIG. 1 shows exemplary components of a vehicle;

FIG. 2a shows an exemplary driving situation of a vehicle;

FIG. 2b shows an exemplary gradient profile of a road;

FIG. 3a shows exemplary predicted distance profiles during the coasting mode;

FIG. 3b shows an exemplary exit time for ending the coasting mode;

FIG. 4 shows an exemplary exit time in a predicted speed profile;

FIG. 5 shows a predicted speed profile with a point of intersection with the target speed; and

FIG. 6 shows a flowchart of an exemplary method for controlling the coasting mode of a vehicle in an open-loop manner.

### DETAILED DESCRIPTION OF THE DRAWINGS

As stated at the outset, the present document deals with increasing the energy efficiency and/or comfort of the coasting mode of a motor vehicle. In this context, FIG. 1 shows an exemplary vehicle 100. The vehicle 100 comprises one or more environmental sensors 102 (for example at least one camera, a radar sensor, a lidar sensor and/or an ultrasonic sensor) which are configured to capture environmental data (that is to say sensor data) relating to the environment of the vehicle 100. The vehicle 100 also comprises one or more vehicle sensors 106 which are configured to capture state data (that is to say sensor data) relating to a state (for example relating to the driving speed) of the vehicle 100.

An (open-loop control) device 101 of the vehicle 100 may be configured to operate the drive motor 103 (in particular the internal combustion engine) of the vehicle 100 on the basis of the environmental data and/or the state data in order to longitudinally guide the vehicle 100 in an at least partially automated manner. In this case, it is possible to effect, in particular, automatic closed-loop distance and/or speed control (in particular ACC, Adaptive Cruise Control) during which the driving speed of the vehicle 100 is automatically set in order to set the distance between the vehicle 100 and a leading vehicle driving directly in front of the vehicle 100 to a target distance (which was specified, for example, by the driver of the vehicle 100) and/or in order to set the driving speed of the vehicle 100 during unobstructed travel (without a leading vehicle) to a target speed (which was specified, for example, by the driver of the vehicle 100).

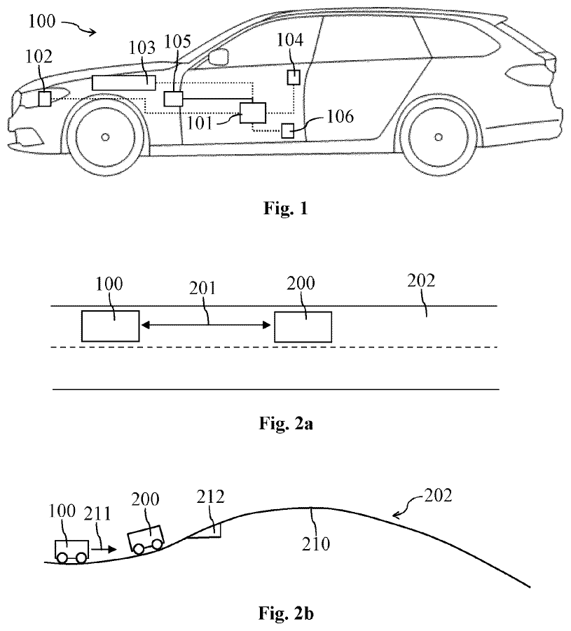

FIG. 2a shows an exemplary driving situation in which the vehicle 100 is driving on a road 202 behind a leading vehicle 200. The distance 201 between the vehicle 100 and the leading vehicle 200 is set to a particular target distance by the device 101 of the vehicle 100. In this case, the distance 201 may be a spatial distance corresponding to the spatial distance (for example measured in meters) between the vehicle 100 and the leading vehicle 200. Alternatively or additionally, the distance 201 may be a temporal distance which corresponds to the time that would be needed by the vehicle 100 at the current driving speed to reach the leading vehicle 200 (assuming that the leading vehicle 200 is stationary). The temporal distance may correspond, for example, to the quotient of the current driving speed of the vehicle 100 and the spatial distance between the vehicle 100 and the leading vehicle 200.

The (open-loop control) device 101 may be configured to at least occasionally operate the vehicle 100 in a so-called coasting mode during active closed-loop distance and/or speed control. For this purpose, the clutch 105 of the vehicle 100 may be caused to decouple the drive motor 103 from the drive train of the vehicle 100, in particular from the one or more driven wheels of the vehicle 100. Furthermore, the drive motor 103 may be deactivated and/or shut down. The vehicle 100 then rolls (without a drag torque and/or without a drive torque of the drive motor 103) over the road 202 used by the vehicle 100. The energy consumption of the vehicle 100 can therefore be reduced.

The vehicle 100 may comprise a position sensor 104 which is configured to capture position data (that is to say sensor data) relating to the respective current position of the vehicle 100. The position data may comprise, for example, coordinates of a global navigation satellite system (GNSS), for instance GPS coordinates. The device 101 may be configured to determine, on the basis of the position data and on the basis of a digital map relating to the road network used by the vehicle 100, the spatial course of the road 202 on which the vehicle 100 will drive. If necessary, a navigation system of the vehicle 100 may have been used to plan a route through the road network. On the basis of the route, it is possible to identify the road 202 along which the vehicle 100 will drive starting from the current time. Furthermore, the spatial course, in particular the gradient profile, of the upcoming road 202 can be determined on the basis of the digital map.

FIG. 2b shows an exemplary gradient profile 210 of the road 202 used by the vehicle 100. The gradient profile 210 indicates the gradient 212 of the road 202 as a function of the position on the road 202 and/or as a function of the time during a journey.

The device 101 may be configured to predict a distance profile and/or a speed profile of the vehicle 100 in the coasting mode on the basis of the gradient profile 210 of the upcoming road 202. The distance profile may indicate the (temporal and/or spatial) distance 201 between the vehicle 100 and the leading vehicle 200 as a function of the position and/or as a function of the time. The speed profile may indicate the driving speed of the vehicle 100 as a function of the position and/or as a function of the time. In this case, it can be assumed that the vehicle 100 is operated in the coasting mode (without the action of a drive and/or braking torque generated by the vehicle 100). Furthermore, a certain speed behavior of the leading vehicle 200 can be assumed (in order to determine the distance profile); it can be assumed, for example, that the leading vehicle 200 will drive at a constant driving speed. The distance profile and/or the speed profile may be predicted, for example, for a spatial prediction horizon of 50 meters or more or of 100 meters or more (starting from the current position of the vehicle 100) and/or for a temporal prediction horizon of 5 seconds or more or of 10 seconds or more.

The activation (also referred to as entry) and/or the deactivation (also referred to as exit) of the coasting mode of the vehicle 100 can then be effected in a precise and energy-efficient manner (when using the closed-loop distance and/or speed controller) on the basis of the predicted distance profile and/or on the basis of the predicted speed profile. In particular, the device 101 of the vehicle 100 may be configured (during operation of the closed-loop distance and/or speed controller) to predict a distance profile and/or a speed profile of the vehicle 100 in the coasting mode on the basis of the current position of the vehicle 100 and/or on the basis of the current time. It is then possible to enter or exit the coasting mode on the basis of the predicted distance profile and/or speed profile.

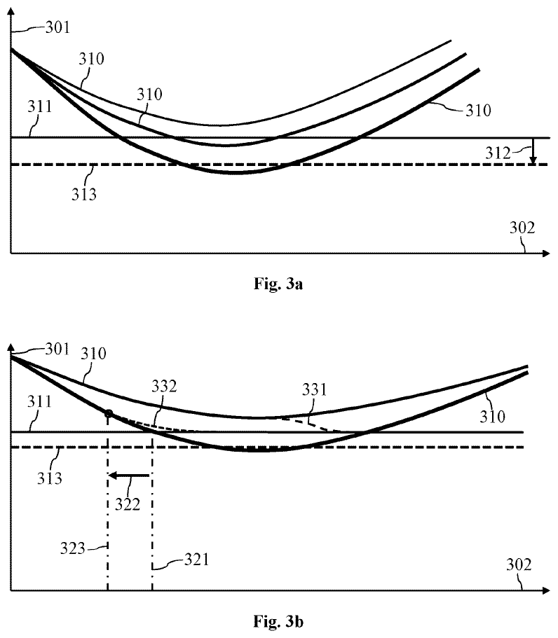

FIGS. 3a and 3b show exemplary predicted distance profiles 310, wherein a distance profile 310 indicates the (temporal or spatial) distance 301 as a function of the driving progress 302 (for example as a function of the time or as a function of the position on the upcoming road 202) of the vehicle 100 starting from the current time or starting from the current position.

The device 101 may be configured to predict a distance profile 310 before entering the coasting mode (during operation of the closed-loop distance and/or speed controller). In this case, it can be assumed that the vehicle 100 is in the coasting mode during the entire prediction horizon. The predicted distance profile 310 can be compared with the target distance 311 for the closed-loop distance controller. In particular, it can be determined whether the predicted distance profile 310 is at least partially below the target distance 311. It is possible to define, for example, a certain penetration depth 312, by which the target distance 311 can be undershot. It is then possible to determine a limit distance 313 that is reduced in comparison with the target distance 311 by the penetration depth 312. The device 101 may be configured to determine whether the predicted distance profile 310 falls below the limit distance 313 for a particular section of the driving progress 302 (that is to say for a particular time period or for a particular position section). This is the case for the predicted distance profile 310 with the thickest line width in FIG. 3a, whereas this is not the case for the two other distance profiles 310.

If it is identified that the predicted distance profile 310 falls below the limit distance 313, it is possible to enter the coasting mode. If, on the other hand, it is identified that the predicted distance profile 310 does not fall below the limit distance 313, entry to the coasting mode may be prevented. This enables a particularly energy-efficient and comfortable coasting mode, in particular because post-acceleration of the vehicle 100 by the drive motor 103 (in order to set the distance 301 to the target distance 311) can be avoided when subsequently exiting the coasting mode.

During the coasting mode, updated predicted distance profiles 310 can be determined repeatedly, in particular periodically, in each case on the basis of the current time and/or on the basis of the current position. As illustrated by way of example in FIG. 3b, an upcoming driving progress point 321 (for example an upcoming time and/or an upcoming position), at which the predicted distance profile 310 intersects the target distance 311 (for the first time), can be predicted on the basis of the respectively predicted distance profile 310. The exit driving progress point 323, at which the coasting mode is exited, can then be determined on the basis of the predicted driving progress point 321. The exit driving progress point 323 can be before the predicted driving progress point 321 by a particular offset value 322.

The defined exit from the coasting mode before reaching the target distance 311 makes it possible to achieve the situation in which the motor vehicle 100 can be braked in a comfortable and energy-efficient manner (for example by the drag torque of the drive motor 103) in order to set the distance 201, 301 of the vehicle 100 to the target distance 311 and in order to change to active closed-loop control of the distance 201, 301. This is illustrated by way of example in FIG. 3b by the distance profile 332.

FIG. 3b also illustrates a situation in which the predicted distance profile 310 does not intersect the target distance 311. In this case, it is possible to exit the coasting mode at a driving progress point 302 at which the distance profile 310 is relatively close (in particular closest) to the target distance 311. However, post-acceleration of the vehicle 100 upon reactivation of the closed-loop distance control is typically required in this case (see distance profile 331), which results in an increased energy consumption and a reduced level of comfort.

The situation for shutting down the internal combustion engine 103 and ending the coasting situation can therefore be assessed, in particular in order to prevent post-acceleration for establishing the target distance 311 to the leading vehicle 200. For this purpose, it is possible to determine a predicted profile 310 of the temporal distance 301 to the leading vehicle 200 on the basis of a gradient forecast 210 and/or on the basis of one or more vehicle parameters (for example the driving speed of the vehicle 100 and/or of the leading vehicle 200) and/or on the basis of the driving situation.

Coasting can possibly be entered only from a particular penetration depth 312 of the predicted coasting profile 310 (that is to say penetration below the target temporal distance 311 to the leading vehicle 200). This criterion makes it possible to compensate for unstable driving situations (for example if the leading vehicle 200 begins an acceleration process and the vehicle 100 would have to carry out post-acceleration with the drive motor 103 in order to adjust the target temporal distance 311). Furthermore, it is thus possible to brake the vehicle to the target distance 311 upon exiting coasting (without post-acceleration to the target temporal distance 311 being required for this). The device 101 may therefore be configured to cause coasting to be entered only from a particular penetration depth 312 of the predicted profile 310 (penetration below the target temporal distance 311 to the leading vehicle 200).

The device 101 may also be configured to determine a point of intersection 321 of the predicted coast-down curve 310 with the target temporal distance 311 to the leading vehicle 200 in order to exit the coasting mode. It is then possible to exit coasting before the target temporal distance 311 to the leading vehicle 311 is reached (with a parameterizable offset value 322). The vehicle 100 can then be braked into the target temporal distance 311 with relatively slight excess dynamics (and there is no need for any shutdown and renewed acceleration).

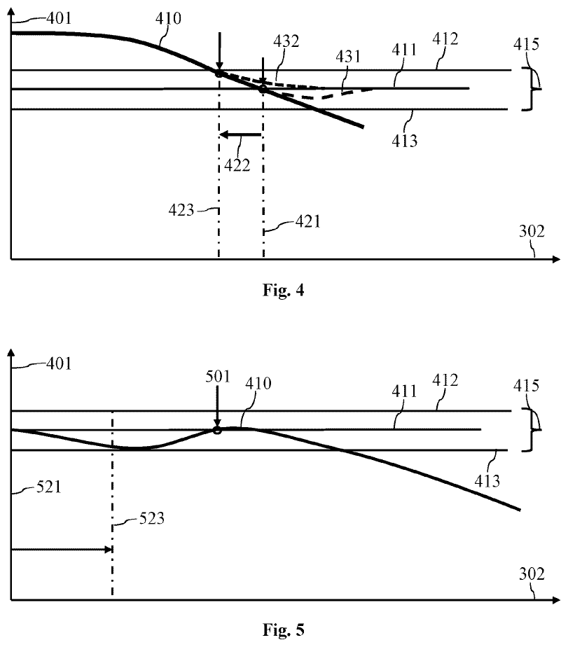

FIG. 4 shows an exemplary predicted speed profile 410 of the vehicle 100 during the coasting mode, wherein the speed profile 410 indicates the driving speed 401 of the vehicle 100 as a function of the driving progress 320. The vehicle 100 is in the coasting mode in the example illustrated in FIG. 4.

The device 101 may be configured to predict, on the basis of the predicted speed profile 410, a driving progress point 421 at which the predicted speed profile 410 intersects the target speed 411 from the closed-loop speed controller (for the first time). In this case, a tolerance band 415 with a lower limit speed 413 and an upper limit speed 412 may possibly be defined around the target speed 411. On the basis of the predicted driving progress point 421, it is possible to determine an exit driving progress point 423 that is before the predicted driving progress point 421 by a defined offset value 422, for example. It is then possible to exit the coasting mode at the determined exit driving progress point 423. It is thus possible to achieve the situation in which the vehicle 100 can be braked to the target speed 411 in a comfortable and energy-efficient manner upon exiting the coasting mode without having to carry out post-acceleration (see speed profile 432 in comparison with the speed profile 431).

The situation for shutting down the internal combustion engine 103 and for ending the coasting situation can therefore be assessed, in particular in order to prevent acceleration to the set and/or target speed 411 (upon exiting the coasting mode). For this purpose, a predicted profile 410 of the driving speed 401 of the vehicle 100 can be determined on the basis of the gradient forecast 210 and/or on the basis of one or more vehicle parameters (for example the driving speed of the vehicle 100) and/or on the basis of the driving situation.

Exit from the coasting mode can be initiated at a parameterizable time 423 before reaching the set speed 411. Post-acceleration to reach the set speed 411 can thus be avoided, thus making it possible to reduce the energy consumption of the vehicle 100.

FIG. 4 illustrates a situation in which the driving speed 401 of the vehicle 100 at the current driving progress point 302 (that is to say at the current time and/or at the current position) is greater than the target speed 411. It is possible to proceed in a corresponding manner in a situation in which the driving speed 401 is below the target speed 411 at the current driving progress point 302 (and there is therefore a coasting mode in the case of a descent of the road 202).

FIG. 5 shows a situation in which the vehicle 100 is operated with an active closed-loop speed controller and without a coasting mode. The device 101 may be configured to predict a speed profile 410 of the vehicle 100 for an assumed coasting mode. On the basis of the predicted speed profile 410, it is possible to check whether the predicted speed profile 410, starting from the current driving progress point 302, 521, has a contiguous driving progress section:
in which the driving speed 401 remains within the tolerance band 415 around the target speed 411; and
which reaches the target speed 411 again at the end 501 of the contiguous driving progress section.

It is then possible to check whether the temporal and/or spatial length of the determined driving progress section has or exceeds a predefined minimum length 523 (starting from the current driving progress point 521). If this is the case, it is possible to enter the coasting mode (at the current driving progress point 521). If, on the other hand, it is identified that the length of the determined driving progress section is less than the predefined minimum length 523, entry into the coasting mode can be prevented. The comfort and the energy efficiency of the vehicle 100 can therefore be increased further.

It is therefore possible to use the condition for entering coasting that the (predicted) coast-down curve 410 reaches the target speed 411 again at the earliest after a predefined minimum coasting time 523, without leaving the tolerance band 415 around the target speed 411. In this case, the gradient forecast 210 can be taken into account when deciding to enter the coasting mode, in order to reduce the energy consumption of the vehicle 100. Furthermore, it is possible to achieve the situation in which the vehicle speed 401 during the coasting mode remains within the tolerance band 415 around the set speed 411. This makes it possible to avoid renewed acceleration from the lower part of the tolerance band 415 to the target speed 411 (a so-called sawtooth profile), thus making it possible to increase the efficiency and the comfort of entering coasting.

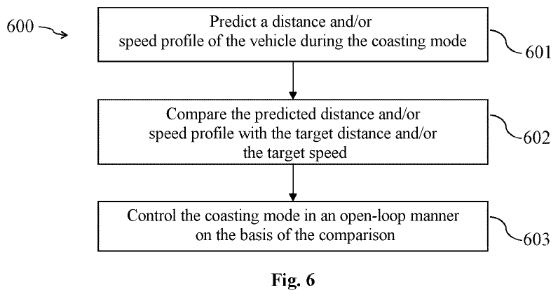

FIG. 6 shows a flowchart of a (possibly computer-implemented) method 600 for controlling the coasting mode of a (motor) vehicle 100 in an open-loop manner as part of closed-loop distance and/or speed control of the vehicle 100, during which the driving speed 401 of the vehicle 100 is set, in particular controlled in a closed-loop manner, on the basis of a target distance 311 to a leading vehicle 200 and/or (in the case of unobstructed travel) on the basis of a target speed 411.

The method 600 comprises predicting 601 a distance and/or speed profile 310, 410 of the vehicle 100 in the coasting mode on the basis of a current driving progress point 302, 521 of the vehicle 100 (in particular on the basis of a current time and/or on the basis of a current position of the vehicle 100). The distance and/or speed profile 310, 410 may be predicted on the basis of the profile 210 of the gradient 212 of the road 202 used by the vehicle 100. In this case, it can be assumed that the vehicle 100 is in the coasting mode (and therefore is not driven by the drive motor 103 and/or no drag torque is therefore effected by the drive motor 103) over the entire predicted distance and/or speed profile 310, 410.

The method 600 also comprises comparing 602 the predicted distance and/or speed profile 310, 410 of the vehicle 100 with the target distance 311 and/or with the target speed 411 from the closed-loop distance and/or speed control of the vehicle 100. In this case, it is possible to determine, in particular, whether the predicted distance and/or speed profile 310, 410 of the vehicle 100 will reach the target distance 311 and/or the target speed 411 (within the prediction horizon for the predicted distance and/or speed profile 310, 410 of the vehicle 100).

The method 600 also comprises controlling 603 the coasting mode in an open-loop manner, in particular starting or ending it, on the basis of the comparison. The comfort and energy efficiency of the vehicle 100 can be increased by determining and evaluating a predicted distance and/or speed profile 310, 410 while carrying out closed-loop distance and/or speed control. In this case, it is possible for the actual distance 201, 301 and/or the actual driving speed 401 to occasionally differ from the target distance 311 and/or the target speed 411 during the coasting mode. The closed-loop distance and/or speed control can therefore be interrupted during the coasting mode. The closed-loop distance and/or speed control can then be automatically resumed upon exiting the coasting mode.

The present invention is not restricted to the exemplary embodiments shown. In particular, it should be noted that the description and the figures are only intended to illustrate by way of example the principle of the proposed methods, devices and systems.

1-16. (canceled)

17. A device for controlling a coasting mode of a vehicle in an open-loop manner as part of at least one of closed-loop distance or a speed control of the vehicle, wherein the device is configured to:
predict at least one of a distance or a speed profile of the vehicle in the coasting mode on the basis of a current driving progress point of the vehicle;
compare the at least one of the predicted distance or speed profile of the vehicle with at least one of a target distance or a target speed from the at least one of the closed-loop distance or the speed control of the vehicle; and
control the coasting mode in an open-loop manner to at least one of start or end the coasting mode on the basis of the comparison.

18. The device according to claim 17, wherein the device is configured, while the vehicle is not operated in the coasting mode, to:
determine whether or not the at least one of the predicted distance or speed profile of the vehicle will at least one of reach the target distance or the target speed at an upcoming driving progress point; and
start the coasting mode at the current driving progress point of the vehicle to start the coasting mode when it is determined that the at least one of the predicted distance or speed profile of the vehicle will at least one of reach the target distance or the target speed.

19. The device according to claim 17, wherein the device is configured, while the vehicle is operated in the coasting mode, to:
determine an upcoming driving progress point at which the at least one of the predicted distance or the speed profile of the vehicle will reach the at least one of the target distance or the target speed;
determine an exit driving progress point on the basis of the determined upcoming driving progress point; and
end the coasting mode at the determined exit driving progress point.

20. The device according to claim 19, wherein the device is further configured to determine an exit driving progress point which is before the determined upcoming driving progress point.

21. The device according to claim 20, wherein the determined exit driving progress point is before the determined upcoming driving progress point by a predefined offset value.

22. The device according to claim 17, wherein the device is configured, while the vehicle is not operated in the coasting mode, to:
predict a distance profile of a distance between the vehicle and a leading vehicle driving in front of the vehicle in the coasting mode;
determine whether or not the predicted distance profile falls below the target distance by at least a predefined penetration depth; and
start the coasting mode when it is determined that the predicted distance profile falls below the target distance by precisely or at least the predefined penetration depth.

23. The device according to claim 17, wherein the device is configured, while the vehicle is operated in the coasting mode, to:
predict a distance profile of a distance between the vehicle and a leading vehicle driving in front of the vehicle during the coasting mode;
determine an upcoming driving progress point at which the predicted distance profile of the vehicle will reach the target distance; and
end the coasting mode at an exit driving progress point that is dependent on the determined upcoming driving progress point.

24. The device according to claim 17, wherein the device is configured, while the vehicle is not operated in the coasting mode, to:
predict a speed profile of the driving speed of the vehicle during the coasting mode;
determine a contiguous driving progress section, starting from the current driving progress point, in which the driving speed of the vehicle remains within a tolerance range around the target speed; and
start the coasting mode when at least one of a temporal or spatial length of the contiguous driving progress section is greater than or equal to at least one of a temporal or spatial minimum length.

25. The device according to claim 24, wherein the device is configured to determine the contiguous driving progress section in such a manner that the predicted speed profile has the target speed at the end of the contiguous driving progress section.

26. The device according to claim 17, wherein the device is configured, while the vehicle is operated in the coasting mode, to:
predict a speed profile of the driving speed of the vehicle during the coasting mode;
determine an upcoming driving progress point at which the predicted speed profile of the vehicle will reach the target speed; and
end the coasting mode at an exit driving progress point that is dependent on the determined upcoming driving progress point.

27. The device according to claim 17, wherein the device is configured to repeatedly, at a sequence of successive driving progress points:
predict at least one of a distance or a speed profile of the vehicle in the coasting mode on the basis of the respective current driving progress point;
compare the respectively predicted at least one of the distance or speed profile of the vehicle with the target at least one of distance or target speed from the at least one of closed-loop distance or speed control of the vehicle; and
control the coasting mode in an open-loop manner to at least one of start or end the coasting mode at the respective current driving progress point on the basis of the comparison.

28. The device according to claim 17, wherein the device is configured to:
determine an upcoming gradient profile of a road used by the vehicle; and
predict the at least one of distance or speed profile of the vehicle in the coasting mode on the basis of the upcoming gradient profile.

29. The device according to claim 17, wherein the device is configured to:
determine state data relating to at least one of a state of the vehicle or a state of a leading vehicle driving in front of the vehicle; and
predict the at least one of distance or speed profile of the vehicle in the coasting mode on the basis of the state data.

30. The device according to claim 17, wherein at least one of:
the at least one of predicted distance or speed profile indicates at least one of a temporal or spatial distance between the vehicle and a leading vehicle driving in front of the vehicle or a driving speed of the vehicle as a function of the driving progress; or
the at least one of predicted distance or speed profile extends over a predefined prediction horizon starting from the current driving progress point.

31. The device according to claim 17, wherein the driving progress comprises at least one of:
a position of the vehicle along a road used by the vehicle; or
a time during a journey of the vehicle.

32. The device according to claim 17, wherein the device is configured to at least one of:
decouple a drive motor of the vehicle from a drive train of the vehicle in order to start the coasting mode; or
couple the drive motor to the drive train of the vehicle in order to end the coasting mode.

33. A method for controlling a coasting mode of a vehicle in an open-loop manner as part of at least one of a closed-loop distance or speed control of the vehicle, the method comprising:
predicting at least one of a distance or speed profile of the vehicle in the coasting mode on the basis of a current driving progress point of the vehicle;
comparing at least one of the predicted distance or speed profile of the vehicle with at least one of a target distance or a target speed from the at least one of the closed-loop distance or speed control of the vehicle; and
controlling the coasting mode in an open-loop manner on the basis of the comparison.

34. The method of claim 33, controlling the costing mode in an open-loop manner comprises controlling at least one of a starting or ending of the coasting mode on the basis of the comparison.
